(19) United States
(12) Patent Application Publication
(10) Pub. No.: US 2026/0328279 A1
(43) Pub. Date: Oct. 22, 2026

(54) DIFFERENTIAL DEVICE

(71) Applicant: GKN Automotive Limited, Birmingham (GB)

(72) Inventors: Shouji Yoshida, Tochigi (JP); Masayoshi Kurokawa, Tochigi (JP)

(21) Appl. No.: 19/649,614

(22) Filed: Apr. 16, 2026

(30) Foreign Application Priority Data
Apr. 22, 2025 (JP) 2025-070396

(51) Int. Cl. F16H 48/40

(52) U.S. Cl. CPC F16H 48/40

(57) ABSTRACT

A differential device receiving torque via a ring gear and thereby rotating about an axis is provided with: a casing having an outer surface cylindrical around the axis and including a flange formed in a unitary body with and projecting radially from the casing, the flange having a flat surface perpendicular to the axis and adapted for connecting with the ring gear; a first fillet tangent to the outer surface and curved toward the flat surface; and a second fillet tangent to the flat surface and curved toward the outer surface, the second fillet being distinguishable from and connected to the first fillet.

### CROSS REFERENCE TO RELATED APPLICATIONS

This application is based upon and claims the benefit of priority from Japanese Patent Application No. 2025-070396 filed on Apr. 22, 2025, the entire contents of which are incorporated herein by reference.

### TECHNICAL FIELD

The disclosure herein relates to a differential device having a rotatable casing with a flange for receiving torque.

### BACKGROUND

As is well known, a vehicle is comprised of one or more differential devices and each of them includes a differential gear set for allowing output shafts to make differential motion. Each differential device is provided with a rotatable casing with a flange projecting radially from the casing, and a ring gear is fixed to the flange to receive and transmit torque to the differential gear set in the casing.

When the flange and the casing form a sharp corner, this corner is sensitive to stress concentration. It is generally to provide a fillet therebetween so as to relieve the stress concentration. The fillet is in general a concave transition surface between surfaces of the casing and the flange. Japanese Patent Application Laid-open No. 2017-215015 discloses a related art.

### SUMMARY

The ring gear fixed to the flange surface has a bevel or chamfer on its internal corner so as to avoid the fillet. While a larger fillet may be advantageous for stress relief, a larger corresponding bevel on the ring gear could compromise its strength. Therefore, there is an inherent limit to the size of the fillet. The disclosure herein is directed to a device having a fillet that enables more effective stress relief under dimensional constraints.

A differential device receiving torque via a ring gear and thereby rotating about an axis is provided with: a casing having an outer surface cylindrical around the axis and including a flange formed in a unitary body with and projecting radially from the casing, the flange having a flat surface perpendicular to the axis and adapted for connecting with the ring gear; a first fillet tangent to the outer surface and curved toward the flat surface; and a second fillet tangent to the flat surface and curved toward the outer surface, the second fillet being distinguishable from and connected to the first fillet.

### BRIEF DESCRIPTION OF THE DRAWINGS

The following detailed description of certain embodiments and best mode will be set forth with reference to the accompanying drawings, in which:

FIG. 1 is a partial perspective view of a differential casing with a flange, in which first and second fillets connecting surfaces of the casing and the flange.

FIG. 2 is a sectional view of the fillets and its surroundings.

FIG. 3 is a partial perspective view of the differential casing with a stress field around the fillets displayed in grayscale.

FIG. 4 is a partial perspective view of a differential casing having a single fillet, showing a stress field using the same grayscale as in FIG. 3.

FIG. 5 is a sectional view of the fillets further including a third fillets.

FIG. 6 is an enlarged view of FIG. 5 around the fillets.

### DETAILED DESCRIPTION

Throughout the following description and the appended claims, an axis means a rotational axis of a rotating machine such as a differential unless otherwise described. Further, the term “fillet” means a concave transition surface formed between two otherwise intersecting surfaces, and the adjective “tangent” is used as a geometric sense, namely meaning that a curved surface meets a plane or another curved surface at a single line and these surfaces share a common direction at the line.

Exemplary embodiments will be described hereinafter with reference to FIGS. through 6 appended to this specification. Drawings are not necessarily made to scale and therefore it is particularly noted that dimensional relations are not limited to those drawn therein.

The following embodiments are directed to a differential device that differentially outputs received torque to a pair of shafts, and may be generally applied to any rotating machine having a flange and a cylindrical body formed in a unitary body with the flange used in combination with a ring gear for receiving torque.

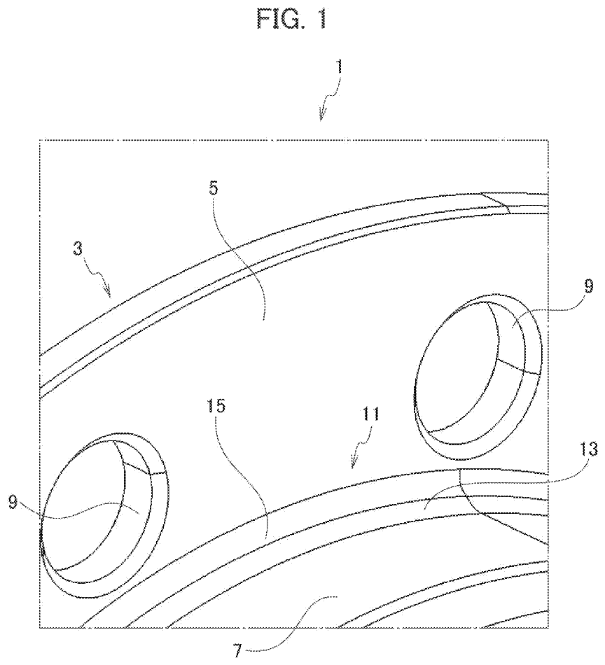

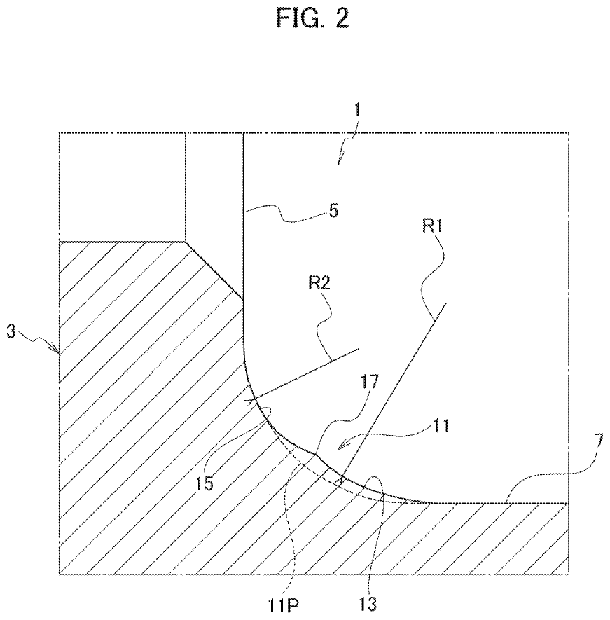

Referring to FIGS. 1 and 2 for example, a differential device 1 is used to differentially distribute torque generated by an engine/motor (not shown) to right and left axles (not shown) for example. The torque is transmitted through a transmission and a propeller pinion led out of the transmission (not shown) to the differential device 1.

The differential device 1 is provided with a casing 3 with a flange 5 formed in a unitary body with the casing 3, to which a ring gear (not shown) is connected. The propeller pinion meshes with the ring gear, thereby inputting the torque to the casing 3. The casing 3 is rotatably supported by a carrier mounted on the vehicle and, driven by the input torque, rotates about an axis. A differential gear set housed in the casing 3, such as a bevel gear set or a helical gear set well-known in this art field, differentially distributes the input torque to the axles. The differential device 1 may be optionally, not necessarily, provided with a locking or limiting configuration that controllably locks or limits differential motion between the axles.

The casing 3 has an outer surface 7 which is cylindrical around the axis, and the flange 5 projects radially outward from the outer surface 7. One of two surfaces of the flange 5, drawn in the foreground in FIG. 2, is used for connecting with the ring gear and is generally a flat surface perpendicular to the axis.

To the casing 3 applicable is a so-called one-piece structure, in which the casing is not divisible and has relatively large openings for inserting internal components. Of course, a two-or three-piece divisible structure is instead applicable.

Between the outer surface 7 of the casing 3 and the flat surface of the flange 5, a fillet section 11 is provided in order to relieve stress concentration induced by the input torque. The fillet section 11 consists of two or more fillets running parallel to each other around the axis, and may be from few millimeters to 10 millimeters in both length and width.

One of the fillets closest to the outer surface 7 is a first fillet 13 tangent to the outer surface 7 and curved toward the flat surface of the flange 5. Referring mainly to FIG. 2, in the cross-section including the axis, the first fillet 13 is drawn as an arc with a curvature radius R1, which is tangent to the outer surface 7. This arc is not limited to a circular arc but may be an oval arc or any arbitrary curve as long as it is tangent to the outer surface 7.

Another of the fillets closest to the flange 5 is a second fillet 15 tangent to the flat surface of the flange 5 and curved toward the outer surface 7. In the cross-section shown in FIG. 2, the second fillet 15 is drawn as an arc with a curvature radius R2, which is tangent to the flat surface of the flange 5. This arc is also not limited to a circular arc but may be an oval arc or any arbitrary curve. As being recognizable at least visually, the second fillet 15 is distinguishable from the first fillet 13.

The first fillet 13 and the second fillet 15 meet together at a ridgeline 17 in the present embodiment. Nonetheless, any curved surface in place of the ridgeline may connect the fillets 13, 15. Related descriptions will be provided later.

FIG. 2 shows a hypothetical line with a broken line, which would be drawn if a single fillet 11P were formed with the same dimensions as the fillet section 11 according to the present embodiment. The aforementioned curvature radii R1 and R2 are intrinsically smaller than a curvature radius of the hypothetical fillet 11P (The fillets 13, 15 are larger in curvature than the hypothetical fillet 11P). It can be conversely pointed that the casing 3 is made thicker in its radial direction around the fillet section 11 than a casing with a single fillet.

As will be readily understood from the aforementioned description, even if the fillet section 11 has generally the same dimensions as a conventional single fillet, the casing 3 with the flange 5 and the plural fillets 13, 15 running in parallel can be thicker around the fillet section 11 than a conventional differential casing with a single fillet. This is advantageous for stress relief around the fillet section 11 and for improving strength, and moreover, does not restrict the design of the ring gear, more specifically the shape of the bevel or chamfer thereof.

No matter how large the curvatures of the fillets 13, 15 (the curvature radii R1, R2 are decreased), the ridgeline 17 standing between the fillets 13, 15 does not come into contact with the bevel of the ring gear fixed to the flange 5. These curvatures are thus arbitrarily selectable. The curvature of the first fillet 13 may be smaller than the curvature of the second fillet 15 (the radius R1 is then larger than the radius R2). This is further advantageous for stress relief around the fillet section 11 and for improving strength without limiting the design of the ring gear.

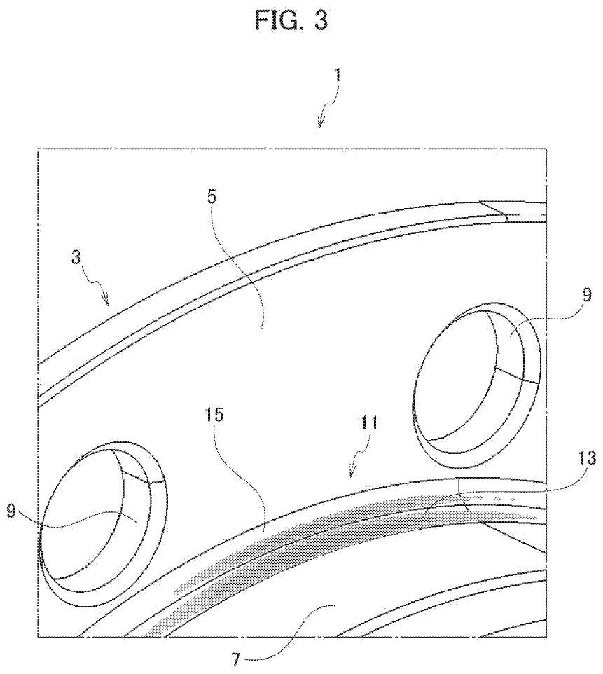

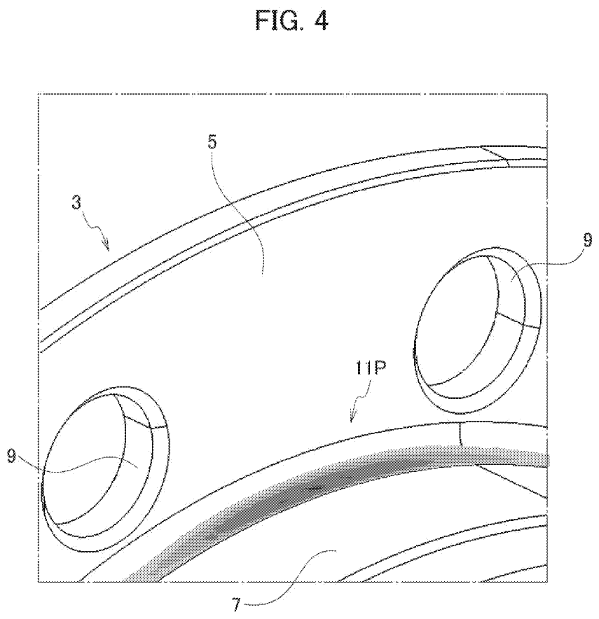

Referring to FIGS. 3 and 4, results obtained by the present embodiment will be demonstrated hereinafter. These drawings illustrate results of stress analysis obtained by a structural analysis software commercially available under the name of “CATIA Analysis GPS”. In each drawing, the stress distribution in the casing was calculated under the assumption that the bearing sections are restrained and a constant load is applied to the differential gear device. The stress levels are displayed using a grayscale divided into 5 steps ranging from white (low) to dark gray (high).

FIG. 3 shows the results about the present embodiment in which the fillet section 11 includes the two parallel fillets 13, 15, and FIG. 4 shows the results about a comparable embodiment in which the single fillet 11P is formed to the same dimensions as the fillet section 11. It is apparent that the present embodiment considerably relieves stress concentration around the fillet section 11 as compared with the single fillet 11P in the comparable embodiment. According to conventional knowledge in this art field, it might be expected that, with respect to stress concentration, fillets with large curvatures and/or a stepped structure such as the ridgeline would be disadvantageous as compared with a single fillet with a small curvature. Contrary to this expectation, these results show that the two parallel fillets considerably relieve stress concentration and, in turn, contribute to improving strength.

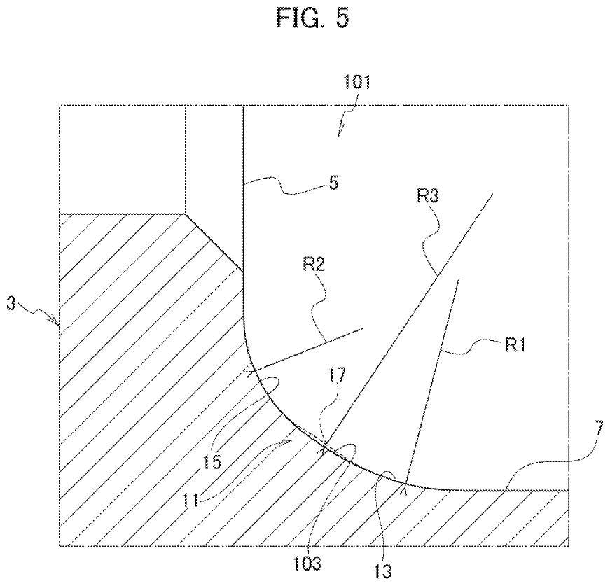

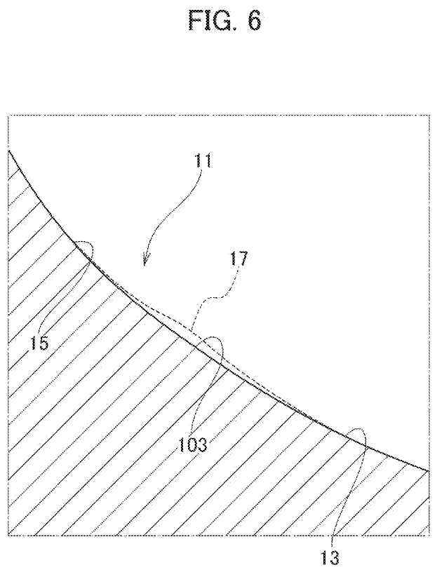

Referring to FIGS. 5 and 6, the ridgeline 17 may be omitted and any proper surface such as a third fillet 103 may be instead formed between the first fillet 13 and the second fillet 15. The third fillet 103 connects the first fillet 13 to the second fillet 15. The third fillet 103 may be formed to be tangent to either the first fillet 13 or the second fillet 15, or both. The third fillet 103 is slightly set back inwardly from a hypothetical ridgeline 17, which is an intersection of extrapolations of the first and second fillets 13, 15, as clearly shown in FIG. 6.

More specifically, a differential device 101 according to the present embodiment is provided with a fillet section 11 including the first, second, and third fillets 13, 15, 103 running in parallel around the axis. The first and second fillets 13, 15 may have the curvature radii R1, R2 identical to those described already. The third fillet 103 may have a larger curvature radius R3 (smaller curvature) than the radii R1, R2.

The addition of the third fillet 103 is further advantageous for stress relief around the fillet section 11. The smaller curvature, if given, of the third fillet 103 than the fillets 13, 15 is also advantageous for stress relief. Omission of the substantial ridge line 17 contributes to prevention of contact between the fillet section 11 and the ring gear.

Needless to say, the fillet section 11 may include four or more fillets running in parallel.

The structures described above can be produced by a combination of conventional casting or forging and machining such as lathe machining without any particular difficulty. For example, the casing 3 with the flange 5 is first formed in a near-net shape by casting or forging. The casing 3 and the flange 5 are next subjected sequentially to facing to form the outer surface 7 and the flat surface. The casing 3 is next subjected to cutting by an end mill to form the first fillet 13, and further subjected to cutting to form the second fillet 15 in parallel. Further cutting may be applied to form the third fillet 103 and additional fillets. Of course, any other process may be used.

Although certain exemplary embodiments are described above, modifications and variations of the embodiments will occur to those skilled in the art, in light of the above teachings.

What is claimed is:

1. A differential device receiving torque via a ring gear and thereby rotating about an axis, comprising:
a casing having an outer surface cylindrical around the axis and including a flange formed in a unitary body with and projecting radially from the casing, the flange having a flat surface perpendicular to the axis and adapted for connecting with the ring gear;
a first fillet tangent to the outer surface and curved toward the flat surface; and
a second fillet tangent to the flat surface and curved toward the outer surface, the second fillet being distinguishable from and connected to the first fillet.

2. The gear unit of claim 1, further comprising:
a third fillet connecting the first fillet to the second fillet.

3. The gear unit of claim 2, wherein the third fillet is tangent to both the first fillet and the second fillet.

4. The gear unit of claim 1, wherein the first fillet is smaller in curvature than the second fillet.
